(19) United States
(12) Patent Application Publication
(10) Pub. No.: US 2005/0081607 A1
(43) Pub. Date: Apr. 21, 2005

(54) Method and apparatus for testing semisolid materials

(76) Inventors: Bhalchandra S. Patel, Glen Allen, VA (US); Paul J. Cooper, Chesterfield, VA (US); Richard J. Kenny, Glen Allen, VA (US); Graham D. Cook, Farnham (GB)

Correspondence Address: ANDREWS KURTH LLP;Intellectual Property Department, Suite 300, 1701 Pennsylvania Avenue, N.W., Washington, DC, 20006, US

(21) Appl. No.: 10/961,184

(22) Filed: Oct. 12, 2004

Related U.S. Application Data
(60) Provisional application No. 60/512,219, filed on Oct. 17, 2003.

(51) Int. Cl. G01N 11/10

(52) U.S. Cl. 73/54.23

(57) ABSTRACT

A method and apparatus for assessing characteristics of a semisolid material is provided. The method and apparatus are particularly well suited for the testing of semisolid cosmetic products in stick form such as lipsticks, lip salves, and deodorant sticks. The method includes testing the rate of deposition of the semisolid material onto a substrate when a test sample of the material is moved against the substrate under controlled conditions. The method also includes measuring the drag on a test sample of the material when the test sample is moved against the substrate under controlled conditions. The illustrated testing apparatus permits a researcher to perform these tests on a test sample. The testing results in qualitative, reproducible data which can be used to compare different batches of the semisolid materials for consistency, and which can be correlated with qualitative human test panel data about the semisolid material for research and development purposes.

### BACKGROUND

This application claims priority from U.S. Provisional Application No. 60/512,219, filed Oct. 17, 2003.

The present invention relates to the field of measuring the characteristics of semisolid materials. More particularly, the invention relates to the field of assessing the physical characteristics of a semisolid cosmetic material which is rubbed onto human skin. However, the principles of the invention may also apply to the testing of semisolid materials other than cosmetics.

Many cosmetic products for application to human skin include a semisolid material ranging in hardness and viscosity from a thickened liquid to a very hard and practically non-viscous material. In some products, such as lip salves, the application of the semisolid material is itself directly beneficial to the skin or person. In other products, such as lipstick, the semisolid material serve as a carrier to deliver color and/or some active composition(s) to the surface of the skin.

Cosmetic products come in many different forms. One of these forms is a so-called “stick” which is usually a rectangular bar or a cylinder of a semisolid material held within a dispensing container and which generally retains its shape while being applied. When a portion of the stick is drawn across the skin's surface, a residue of the semisolid material is transferred to and deposited on the skin. Examples of types of cosmetic products which may be provided in stick form include lipsticks, lip salves, deodorants, moisturizers, sunscreens, and eyebrow pencils. Typically sticks are wax-structured sticks, gels, or gellant compositions wherein the stick comprises a liquid of increased viscosity rather than a waxy material or gel. Examples of wax-structured sticks are given in U.S. Pat. Nos. 5,169,626 and 4,725,432. This invention relates particularly to the testing and measuring of cosmetics in “stick” form, but may be used to test and measure cosmetic products in other forms, and non-cosmetic materials.

ASTM methods D-1321 and D-937 provide examples of testing procedures for semisolid cosmetic materials. These methods measure the semisolid material's hardness by probing with a needle or conical probe. The measurements obtained from this probing correlate to the material's hardness and may be used to identify batch to batch differences in the material's characteristics. But the data obtained is difficult if not impossible to relate to real product performance, i.e., the quality or desirability of the product as perceived by the users.

Shiseido America, Inc., has developed a proprietary device to test for lipstick breakage. In the Shiseido tester a lipstick holder holds a lipstick sample at a 60 degree angle. When the automated device is turned on, the lipstick holder moves side to side on paper while the paper moves forward. As the Shiseido apparatus is currently used, a stroke counter counts the number of times that the arm swings from side to side, and if the stroke counter reaches fifty, the lipstick composition is deemed to pass the test. No provision is made for any other measurement. Thus, propensity for breakage is determined compared to an arbitrarily determined standard and is not readily related to product performance.

Human test panels are typically used to assess the amount of residue left on human skin and whether the composition is desirable from a human “feel” perspective. In panel testing, consumers are given a sample of the semisolid cosmetic composition and asked to apply the composition to the relevant area. Upon application, consumers are asked to rate how the composition feels on their skin and to rate the experience on a relative scale. The results are subjective. There is little ability through these tests to correlate the hardness of the semisolid material and consumer satisfaction. Additionally, reproducibility and consistency of test results are difficult to achieve.

Thus, there exists a need for a method to test semisolid cosmetic materials in an objective and reproducible manner where the test results can be correlated to the “feel” or performance of the semisolid cosmetic material from the user's perspective.

### BRIEF DESCRIPTION OF THE DRAWINGS

FIG. 1 Shows an exemplary embodiment of a test apparatus according to the invention;

FIG. 2 Shows a detailed view of the test arm assembly of the test apparatus of FIG. 1;

FIG. 3 Shows an alternative embodiment of a sample holder.

### DETAILED DESCRIPTION OF THE INVENTION

The invention provides a means for objectively and reproducibly testing samples of a semisolid material. Data obtained from this testing permits accurate, objective evaluations of the semisolid material of one test sample against that of another test sample. For example, the data could be used to ensure batch to batch quality and consistency of a semisolid material. Although not necessarily replicating the characteristics of human use of the semisolid material, data obtained from this assessment is believed to approximately correspond with performance during human use of the semisolid material. Therefore, the data can also be used to evaluate the semisolid material against a set of target criteria that correlate to desired performance during human use of the semisolid material. For example, the data can be used to identify a composition of a semisolid cosmetic material which has certain characteristics desired by consumers.

As used herein, a test sample means any semisolid material formed into a three dimensional shape such as a stick, ball, etc. The test sample may comprise only the semisolid material, which may be homogeneous, or the test sample may also comprise materials or structures for holding, supporting, and containing the semisolid material. For example, the test sample may comprise only a (preferably a homogeneous) length of a lipstick stick. Or, the test sample may comprise a lipstick stick within a plastic tube for containing and holding the stick.

As used herein, a semisolid material means any semisolid material at least a portion of which is capable of being transferred onto a substrate from a test sample when the test sample and the substrate are moved against one another. The term “moved against one another” means moved relative to one another while in physical contact. The semisolid material could be a cosmetic or an active agent for application to human skin, including wax-structured sticks, gel sticks, or gellant sticks which comprise lip salves, lipsticks, deodorants, moisturizers, sunscreens, or eyebrow pencils. However, the invention is not limited to the evaluation of cosmetic or active agents for use on human skin.

The invention provides a method and device for assessing characteristics relating to the deposition of a semisolid material from a test sample onto the substrate when the test sample and the substrate are moved against one another under controlled conditions. One of the characteristics assessed is the rate of deposition of the semisolid material onto the substrate. Another characteristic is the drag produced by friction between the test sample and the substrate when the test sample and the substrate are moved against one another. Other characteristics may include the visual appearance of the semisolid material residue on the substrate. For example, it may be useful to perform a visual inspection of the thickness, consistency, color, or reflectivity of the residue on the substrate.

In brief, the method comprises moving the test sample and the substrate against one another to deposit some of the semisolid material onto the substrate. The movement is performed under controlled conditions. For example, the relative speed and duration of the movement may be controlled. The path of the test sample moving against the substrate may also be prescribed. The force with which the test sample is pressed against the substrate may also be controlled. Of course, the type and surface characteristics of the substrate may also be controlled. It may be necessary or desirable to control the ambient temperature and humidity when the testing is performed.

After the movement of the test sample and the substrate against one another has been performed, either the test sample or the substrate can be weighed to determine the quantity of semisolid material lost from the test sample or deposited onto the substrate. The quantity of the semisolid material deposited onto the substrate correlates with the rate of deposition of the material onto the substrate. If a first test sample deposits more residue on the substrate than a second test sample, and all the relevant conditions for each test are controlled and kept the same, then the first sample has a greater rate of deposition than the second sample.

It may also be beneficial to measure the drag force against the test sample from the substrate when the two are moved against one another. A force measuring device may be employed in the testing apparatus to measure the drag.

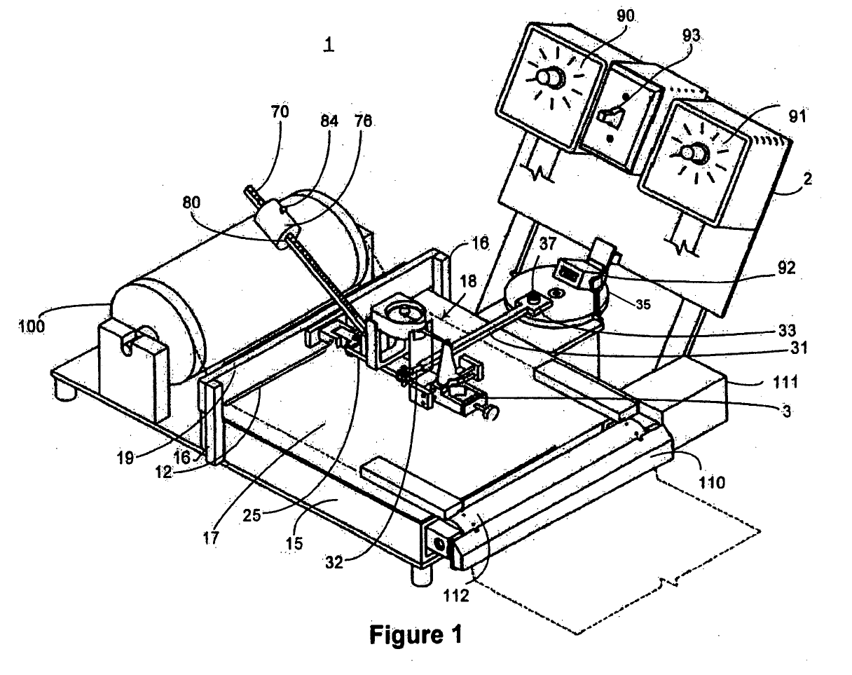

An exemplary embodiment of testing apparatus 1 is shown in FIG. 1. Testing apparatus 1 is merely one example of an apparatus to permit testing of a semisolid material according to the present invention. Readers will recognize that the exemplary testing apparatus 1 can be modified in a myriad of ways and the arrangement of parts on the assembly can be modified and improved to suit particular needs.

The testing apparatus 1 has a base assembly 15. The base assembly 15 provides support for a substrate 17. As one skilled in the art will appreciate the base assembly 15 may have any of a variety of shapes and configurations so long as it supports the substrate 17 in a position proximate to the test sample. A sample holder 3 positions the test sample in contact with the substrate 17.

The test sample and the substrate 17 are moved against one another so that some of the semisolid material in the test sample is rubbed off and deposited onto the substrate. In the exemplary testing apparatus 1, the substrate 17 is moved across the top surface of the base assembly 15. With the sample holder 3 being indirectly attached to the base assembly 15, the substrate 17 thus moves relative to the test sample. Alternatively, it is also contemplated, and those of skill in the art will recognize that the substrate 17 may also be attached to the base assembly 15 in a stationary manner, and the sample holder 3 can be moved relative to the base assembly 15 and the substrate 17. Or, as will be described in greater detail hereinafter, both the substrate 17 and the test sample may have a component of movement relative to the base assembly 15. The movement of the substrate 17 relative to the sample holder 3 can be accomplished by any suitable method and any suitable mechanism.

In the exemplary testing apparatus 1 shown in FIG. 1, a strip chart recorder mechanism is used to move the substrate 17 over the top of the base assembly 15. Strip chart recorders are known and may comprise a roller 100 which can be used to store a large quantity of the substrate 17. A substrate guide bar 12 positioned on a support member 19 can be used to guide the substrate 17 as it is unrolled from the roller 100. The substrate is unrolled from the roller 100 and pulled across the base assembly 15 and underneath the sample holder 3 through a drive roller and guide assembly 110. The drive roller and guide assembly 110 includes a motor 111 which drives a drive roller 112. The drive roller 112 can have a high friction surface or teeth that grab the substrate 17 and pull it off of the roller 100 and across the top of the base assembly 15. The speed and/or angular position of the motor 111 and/or the drive roller 112 can measured and controlled. Optionally, the strip chart recorder mechanism may be equipped for cutting the movable substrate 17 into predetermined lengths to facilitate weighing of the substrate after the deposition of a semisolid material thereon.

Alternatively, a conveyor or weighing belt may be used as a movable substrate. A weighing belt measures directly the deposition of the semisolid material as the testing apparatus is operated. One example of such a device known in the art is a continuous belt which moves between two rollers and is associated with a weighing mechanism. A portion of the conveyor or weighing belt should be positioned under the sample holder 3 and in contact with the test sample. Parameters such as the speed and position of the conveyor or weighing belt should be controllable. Use of a conveyor or weighing belt may facilitate the interfacing of the testing apparatus to a computer system for the processing and storage of test data. With a conveyor or weighing belt it may be desirable to provide a system for removing the semisolid material residue from the belt.

As another alternative, a turntable type device may be used to move the substrate 17. The turntable device may include an integral substrate surface upon which the semisolid material can be deposited. The turntable device may alternatively include a surface upon which a removable substrate may be attached through, e.g., a pressure sensitive adhesive coating on the substrate. The turntable device would rotate on the base assembly 15 with a portion of the turntable device adjacent to the sample holder 3 so that the test sample contacts the substrate. A turntable device with a removable substrate secured thereon would provide the advantage of quick and accurate determination of the substrate's weight before and after the deposition of the semisolid material.

The substrate 17 may be formed from any suitable material such as paper or polymeric sheet or film which is compatible with the semisolid material to be tested and provides an adequate amount of friction so that the semisolid material will be rubbed off of the test sample and onto the substrate. For example, a polyurethane or silicone polymer sheet or film may be used to form substrate 17. When testing certain semisolid cosmetic materials, it may be desirable to select polymeric materials which have surface characteristics that correlate with characteristics of human skin. Some surface preparation of the substrate 17, such as dampening or wetting, may be desirable before the testing is performed. The material from which substrate 17 is formed should have reasonably consistent characteristics and should be reproducible.

As shown in FIG. 1, the support member 19 is positioned above the base assembly 15 by struts 16. The struts 16 are positioned at a sufficient distance from one another such that the substrate 17 may pass between the struts 16 and on top of the base assembly 15 and below the support member 19. The substrate guide bar 12 is positioned on the support member 19 to guide and control the passage of the substrate 17 and to ensure even movement of the substrate 17 on top of the base assembly 15. The substrate guide bar 12 may be adjustably positioned on the support member 19 so that it can be adjusted for substrates of differing thicknesses.

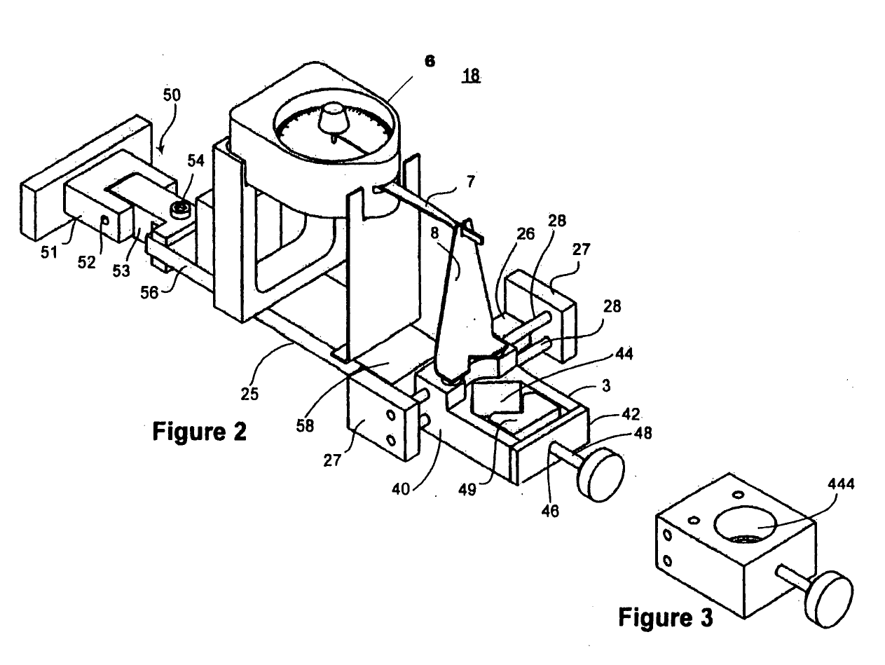

Support member 19 positions a test arm assembly 18 over the base assembly 15. FIG. 2 provides a detail view of the test arm assembly 18. Test arm assembly 18 comprises a first arm member 25 with opposite first end 56 and second end 58. First end 56 of the first arm member 25 is attached to support member 19 via a universal-type joint 50.

The universal-type joint 50 enables the first arm member 25 to have several degrees of freedom of movement relative to the support member 19. Other types of suitable joints may be used to connect first arm member 25 to support member 19. First arm member 25 could also be directly connected to the base assembly 15. The universal-type joint 50 includes a first joint member 51 attached to the support member 19, a second joint member 53 pinned to the first joint member 51 via first pin 52, and first end 56 pinned to the second joint member 53 via second pin 54. First pin 52 permits rotation of the first arm member 25 about an approximately horizontal axis, and second pin 54 permits rotation of the first arm member about an approximately vertical axis. Sample holder 3 is mounted to the second end 58 of first arm member 25. The universal-type joint 50 permits the sample holder 3 to move approximately horizontally and vertically relative to the substrate 17.

In the embodiment shown in FIG. 2, the sample holder 3 has a first end 40 and a second end 42 and an orifice 44. The orifice 44 accommodates the test sample. The orifice 44 runs completely through sample holder 3 and its axis is normal to the surface of the substrate 17. If desirable, the orifice 44 could also be angled so that the test sample contacts the substrate 17 at an angle. The sample holder 3 may include a clamp for holding the test sample in position. The second end 42 of the sample holder 3 may have a threaded hole 46 to accommodate a threaded rod 48. The threaded rod 48 can be threaded through the threaded hole 46 into the orifice 44 to cause a block 49 to be pushed against and secure the test sample. For example, when a cosmetic container such as a lipstick tube is placed in orifice 44 of sample holder 3, the rod 48 may be rotated until block 49 applies force to the cosmetic container securing it for testing. If the test sample does not include a container for holding the semisolid material, the block 49 may bear directly against the semisolid material.

The sample holder 3 may be removable from first arm member 25. This arrangement permits exchanging holders and provides for customization of the size and/or shape of the holder orifice 44 to a specific test sample. FIG. 3 shows an alternative embodiment of a sample holder with a customized holder orifice 444. Such customization may be desirable when a number of samples of the same kind are to be analyzed, such as in a quality assurance type test.

Referring again to FIG. 2, sample holder 3 is attached to the second end 58 of the first arm member 25 via a sliding joint arrangement. The sliding joint arrangement permits the sample holder to slide relative to the first arm member 25 in a direction transverse to the direction of travel of the substrate 17. The sliding joint arrangement includes a cross member 26 fixed to the second end 58 of the first arm member 25. Parallel blocks 27 are attached to each end of cross member 26 and position two parallel gliding bars 28. The sample holder 3 includes through bores through which the gliding bars 28 pass in a sliding fit. Thus, the sample holder 3 can move transversely from a position adjacent to the right side parallel block 27 to a position adjacent to the left side parallel block 27.

The force with which the sample holder 3 presses the test sample against the substrate 17 is one of the conditions which may be necessary to control in order for the test to be reproducible. As used herein, the force of the test sample against the substrate 17 is known if either the force is measured quantitatively, or, simply, if the force can be reproduced for other tests. In the testing apparatus 1 in FIG. 1, the weight of the first arm member 25, the force measuring device 6, and other associated components of the test arm assembly 18 act to create the force of the test sample against the substrate 17. If the weight of these components remains constant, the force is known and the test can be reproduced accurately. If the weight of these components is not adequate or is too great for effective testing, the weight can be adjusted with weights or counterweights.

The testing apparatus 1 of FIG. 1 is provided with a counterweight to reduce the effective weight of the test arm assembly 18 and to adjustably set the force of the test sample against the substrate 17. It will be readily recognized that a testing apparatus may be outfitted with weights and counterweights in many different ways to adjust the force of the test sample against the substrate. The counterweight setup depicted in FIG. 1 is one example. Referring to FIG. 1, a load arm 70 is attached to the first arm member 25. The load arm 70 mounts a weight 76. The weight 76 is cantilevered over the first pin 52 opposite the sample holder 3. The position of the weight 76 on the load arm 70 corresponds to the amount of counterbalancing provided. The position of weight 76 may be adjusted to adjust the force of the test sample against the substrate 17. The load arm 70 may have inscriptions along its length to facilitate positioning of the weight 76 at a reproducible distance from the first pin 52. The weight 76 may be mounted to the load arm 70 via a through hole 80 formed in the weight 76 through which the load arm 70 may pass. A clamp screw 84 may pass through the weight 76 and clamp it to the load arm 70 to retain the position of the weight 76.

A second arm member 31 has a first end 32 and an opposing second end 33. The first end 32 is attached to the first arm member via a ball and socket joint, pillow block and bearing, or other suitable loose fitting joint that ideally permits movement between second arm member 31 and the first arm member 25 except in the direction transverse to the movement of substrate 17. The second end 33 of the second arm member 31 is rotatably attached to an eccentric crank 37 mounted on a rotating plate 35. The rotating plate 35 can be rotated about its center by an electric motor (not shown) or other suitable means. The rotating plate 35 and the second arm member 31 operate similarly to a slider-crank mechanism. As rotating plate 35 rotates, the eccentric crank 37 causes the second arm member 31 to drive the test arm assembly 18 in an oscillating motion. The oscillating motion is a reciprocal pivoting of the test arm assembly 18 about second pin 54.

The motor which rotates the rotating plate 35 may be attached to a controller 90 to permit controlling the rotational speed of rotating plate 35 and consequently the speed of the oscillating motion of the test arm assembly 18. A counter 92 may also be used to count the number of rotations of rotating plate 35 and consequently the number of oscillations of the test arm assembly 18. The controller 90 and counter 92 can be any suitable device as will be recognized by those in the art.

The provision for an oscillating motion transverse to and in addition to the travel of the substrate 17 is optional. If the oscillating motion is desired, the mechanism for oscillating the test arm assembly 18 can be arranged in many different ways. The mechanism illustrated herein is merely exemplary.

As shown in FIG. 1, a control panel 2 may be attached to the base assembly 15. The controller 90 for the motor which drives the rotating plate 35 may be conveniently mounted on the control panel 2. Also, a controller 91 for controlling the speed of motor 111 which drives the drive roller 112 may be conveniently mounted on the control panel 2. A power switch 93 may also be mounted on the control panel 2.

A force measuring device (or gauge) 6 may be attached to the first arm member 25 to measure the drag on the test sample. In the example shown in FIG. 2, the force measuring gauge 6 is fitted into a receptacle that is custom made for that type of gauge. Any suitable force measuring device in any suitable configuration may be used for measuring the drag. In particular, the drag may be measured in different directions than the direction measured in the embodiment in FIG. 2. The force measuring gauge 6 is attached to the sample holder 3 via needle 7 and post 8. Post 8 is fixed to the sample holder 3 and moves transversely along with the sample holder 3 as sample holder 3 moves on the gliding bars 28. When post 8 moves transversely, it actuates the needle 7 of the force measuring gauge 6. When the needle 7 is moved, the force measuring gauge 6 gives a measurement of the drag force acting transversely (parallel to the gliding bars 28) on the sample holder 3. The force measuring gauge 6 may have the ability to detect the greatest drag felt by the sample holder 3 during the course of a test and keep that greatest drag measurement on its display until the force measuring gauge 6 is reset for another test. Or the force measuring gauge 6 may be associated with electronics which can compute the average drag over a period of time. In general, the drag on the test sample could be measured in many different ways and the setup illustrated herein is only exemplary.

To use the testing apparatus 1 to measure the characteristics of a semisolid material, the test sample is placed in the sample holder 3. The sample holder 3 presses the test sample against the substrate 17. The substrate 17 is moved across the top of the base assembly 15 by the drive roller 112 and the motor 111. While the substrate 17 moves, a portion of the semisolid material is rubbed off of the test sample and deposited on the substrate 17.

If desired, and appropriate provisions on the test apparatus have been made, the sample holder 3 may be oscillated transversely at the same time as the substrate 17 is moving. The two components of movement, the movement of the substrate 17 and the oscillating movement of the sample holder 3, may be beneficial by requiring a lesser amount of substrate to perform a given test. Also, the changing of direction of the test sample motion relative to the substrate 17 that results from the oscillating motion may more accurately replicate how a semisolid cosmetic product is actually used by a person.

Preferably, when the oscillating component of movement is used, the substrate 17 should be moved at a speed which reduces the area of the substrate 17 which is contacted more than once by the test sample. For accuracy, it is preferred that the test sample contact as much as possible only a fresh area of the substrate 17 that does not yet have any residue of semisolid material.

To determine the pay-off, i.e., the amount of semisolid material that is transferred to the substrate 17 from the semi solid cosmetic stick during the test, the test sample can be weighed before and after the test run. The difference between the weight before and after the test run will be the amount of semisolid material that is pay-off. Alternatively, in some test circumstances it may be more advantageous to weigh the substrate before and after the test run with the difference in weight before and after being the amount of pay-off. Several test runs of each test sample may be desirable to see that the pay-off of the semisolid material is consistent for each test run.

Testing apparatus 1 is particularly well suited for testing semisolid cosmetic products in stick form. Typically such semisolid cosmetic products for example, lipsticks, lip salves, or deodorant sticks, for example, are stored in plastic and metal dispensers or containers. It is not necessary to remove the stick from the container, and it is typically more convenient to retain the semisolid stick in the container during testing. With some cosmetic products, before weighing the test sample, it is preferable to advance the stick out of the container so that a portion of the stick is exposed. Then the end of the stick may be cut off to leave a flat surface on the end of the stick that will be generally parallel to the surface of substrate 17 when the test sample is mounted in sample holder 3.

After weighing, the test sample is inserted into the sample holder 3 of the testing apparatus 1 with the flat surface on the end of the stick contacting the substrate 17. Optionally, a weight or counterweight may be applied to the test arm assembly 18 so that the force of the test sample against the substrate 17 is appropriate for the test. If a weight or counterweight is applied, its position and weight should be noted to facilitate reproducing the conditions for later tests.

Once the semisolid stick sample to be tested is positioned in the apparatus, motion of the substrate 17 and the sample holder 3 (if desired) is initiated. The displacement of the test sample relative to the substrate can be recorded and controlled through, for example, counting the number of transverse oscillations with the counter 92. Other ways to record and control the displacement of the test sample may include simply timing the duration of the test, noting the length of the residue mark on the substrate, counting the number of rotations of the drive roller 112, etc. Any suitable method can be used to record and control the length of the test samples movement against the substrate 17. As used herein, the displacement is known if either the magnitude of displacement is measured, or, simply, if the displacement can be reproduced in later tests.

After a predetermined number of oscillations have been completed, the test sample can be removed and weighed with the difference in weight before the test and after the test reflecting the amount of semisolid material paid-off.

The drag of the test sample may be measured independently or simultaneously with the testing of the rate of deposition of the semisolid material onto the substrate. After the test sample is secured in the sample holder 3, the force measuring gauge 6 is zeroed. The movement of the test sample relative to the substrate 17 is then initiated. The movement may be one or two components of movement, as desired for the particular semisolid material and test to be performed. The amount of drag is noted by reading the force measuring gauge 6 at any point during the motion. So long as the point at which the gauge is read as well as conditions of motion of the test sample and substrate 17 are the same, reproducible quantitative data for sample to sample comparison may be obtained.

The inventors acknowledge that the experimental conditions of the methods disclosed herein are not expected to replicate precisely the use of semisolid cosmetic materials on human skin. Nevertheless, the inventors believe that this data may be effectively correlated to human response, and that the data does provide for reproducible quantitative sample to sample comparisons. Both rates of residue deposition and the drag of the semisolid cosmetic material can be important to users. In the case of semisolid cosmetic materials intended for application to the lips, residue deposition and drag characteristics are important indicators of a term known in the art as “mouth feel.” Mouth feel is believed to be an important factor for consumers.

The following three charts describe exemplary tests that were performed on a lipstick product according to the methods and with the apparatus illustrated in FIGS. 1-3 of the present invention. The three charts also contain exemplary data from those tests:

### Lipstick Pay-off Data Charts

| | | | | | | | | | |
|---|---|---|---|---|---|---|---|---|---|
| | | | | Load | | | | | |
| | | | | (g/cross | | | | | |
| | | | | sectional | Tension | Initial | Final | | |
| Machine | | Product/ | | surface | Reading | weight | weight | % | % |
| Setting | Strokes | Lot# | Sample | area) | (g) | (g) | (g) | Pay off | Average |

Variable # Of Strokes

| | | | | | | | | | |
|---|---|---|---|---|---|---|---|---|---|
| Stroke | 25 | A | 1 | 19.5 | 17 | 10.684 | 10.561 | 1.15 | 1.15 |
| Speed 40 | | | 2 | 19.5 | 18 | 10.641 | 10.525 | 1.09 | |
| Paper roll | | | 3 | 19.5 | 19 | 10.597 | 10.466 | 1.23 | |
| speed 40 | | | | | | | | | |
| Stroke | 50 | A | 1 | 19.5 | 21 | 10.626 | 10.370 | 2.40 | 2.29 |
| Speed 40 | | | 2 | 19.5 | 20 | 10.662 | 10.419 | 2.27 | |
| Paper roll | | | 3 | 19.5 | 20 | 10.739 | 10.500 | 2.22 | |
| speed 40 | | | | | | | | | |
| Stroke | 75 | A | 1 | 19.5 | 19 | 10.727 | 10.384 | 3.19 | 3.28 |
| Speed 40 | | | 2 | 19.5 | 19 | 10.701 | 10.372 | 3.07 | |
| Paper roll | | | 3 | 19.5 | 22 | 10.720 | 10.334 | 3.60 | |
| speed 40 | | | | | | | | | |

Variable Load

| | | | | | | | | | |
|---|---|---|---|---|---|---|---|---|---|
| Stroke | 25 | A | 1 | 25.0 | 20 | 10.687 | 10.546 | 1.31 | 1.14 |
| Speed 40 | | | 2 | 25.0 | 18 | 10.536 | 10.419 | 1.11 | |
| Paper roll | | | 3 | 25.0 | 17 | 10.668 | 10.559 | 1.02 | |
| speed 40 | | | | | | | | | |
| Stroke | 25 | A | 1 | 50.0 | 29 | 10.663 | 10.481 | 1.42 | 1.52 |
| Speed 40 | | | 2 | 50.0 | 29 | 10.736 | 10.576 | 1.49 | |
| Paper roll | | | 3 | 50.0 | 28 | 10.594 | 10.417 | 1.67 | |
| speed 40 | | | | | | | | | |
| Stroke | 25 | A | 1 | 75.0 | 28 | 10.681 | 10.504 | 1.65 | 1.61 |
| Speed 40 | | | 2 | 75.0 | 31 | 10.621 | 10.457 | 1.54 | |
| Paper roll | | | 3 | 75.0 | 32 | 10.618 | 10.442 | 1.65 | |
| speed 40 | | | | | | | | | |

Variable Speed of Stroke

| | | | | | | | | | |
|---|---|---|---|---|---|---|---|---|---|
| Stroke | 25 | A | 1 | 19.5 | 19 | 10.660 | 10.536 | 1.16 | 1.10 |
| Speed 40 | | | 2 | 19.5 | 20 | 10.739 | 10.621 | 1.10 | |
| Paper roll | | | 3 | 19.5 | 18 | 10.625 | 10.515 | 1.04 | |
| speed 60 | | | | | | | | | |
| Stroke | 25 | A | 1 | 19.5 | 19 | 10.640 | 10.541 | 0.930 | 0.958 |
| Speed 60 | | | 2 | 19.5 | 19 | 10.695 | 10.589 | 0.991 | |
| Paper roll | | | 3 | 19.5 | 20 | 10.595 | 10.494 | 0.953 | |
| speed 60 | | | | | | | | | |
| Stroke | 25 | A | 1 | 19.5 | 18 | 10.655 | 10.566 | 0.835 | 0.843 |
| Speed 80 | | | 2 | 19.5 | 18 | 10.683 | 10.600 | 0.777 | |
| Paper roll | | | 3 | 19.5 | 21 | 10.676 | 10.578 | 0.918 | |
| speed 60 | | | | | | | | | |

The following chart of data obtained from tests conducted in accordance with the methods and apparatus described herein was correlated with data from a human test panel. The panel participants judged the desirability of each product in terms of the product's color, shine, feel, coverage/pay-off, wear, etc. With respect to the coverage/pay-off rating, the test panel selected product B as having the best rating, followed by product C and then product D. The products B, C and D were lipsticks. The preference results of the test panel compare favorably with the results of the objective testing.

| | | | | Load | | | | | |
|---|---|---|---|---|---|---|---|---|---|
| | | | | (g/cross | | | | | |
| | | | | sectional | Tension | Initial | Final | | |
| Machine | | Product/ | | surface | Reading | weight | weight | % | % |
| Setting | Strokes | Lot# | Sample | area) | (g) | (g) | (g) | Pay off | Average |
| Stroke | 25 | B | 1 | 23.9 | 26.0 | 10.728 | 10.597 | 1.22 | 1.13 |
| Speed 40 | | | 2 | 23.9 | 26.0 | 10.568 | 10.445 | 1.16 | |
| Paper roll | | | 3 | 23.9 | 23.0 | 10.641 | 10.531 | 1.03 | |
| speed 40 | | | | | | | | | |
| Stroke | 25 | C | 1 | 23.9 | 18.5 | 10.732 | 10.649 | 0.773 | 0.798 |
| Speed 40 | | | 2 | 23.9 | 20.0 | 10.728 | 10.638 | 0.838 | |
| Paper roll | | | 3 | 23.9 | 22.5 | 10.566 | 10.483 | 0.785 | |
| speed 40 | | | | | | | | | |
| Stroke | 25 | D | 1 | 23.9 | 16.5 | 10.887 | 10.828 | 0.541 | 0.537 |
| Speed 40 | | | 2 | 23.9 | 21.0 | 10.883 | 10.823 | 0.551 | |
| Paper roll | | | 3 | 23.9 | 20.0 | 10.961 | 10.904 | 0.520 | |
| speed 40 | | | | | | | | | |

Although the invention has been described through a description of a particular sequence of steps in a method, and a particular arrangement of components on a testing apparatus, those in the art will recognize that various modifications and variations can be made without departing from the spirit or scope of the invention. The foregoing descriptions are illustrative only and are not intended to limit the scope of the invention in any way. The scope of the invention shall be defined by the appended claims.

1. A method of measuring properties of a semisolid material comprising:
contacting a test sample of the semisolid material against a substrate with a known force between the test sample and the substrate;
moving the test sample relative to the substrate with a known displacement of the test sample relative to the substrate to deposit some of the semisolid material from the test sample onto the substrate; and
determining the amount of semisolid material that has been removed from the test sample and deposited onto the substrate.

2. A method of measuring properties of a semisolid material comprising:
contacting a test sample of the semisolid material against a substrate with a known force between the test sample and the substrate;
moving the test sample relative to the substrate to deposit some of the semisolid material from the test sample onto the substrate; and
while the test sample is moving relative to the substrate, measuring the drag force imposed on the test sample by its movement relative to the substrate and by its contact with the substrate.

3. An apparatus for measuring the properties of a semisolid material comprising:
a base assembly;
a holder which holds a test sample of the semisolid material positioned above the base assembly;
a substrate positioned between the base assembly and the holder for moving relative to the test sample, the test sample and the substrate being in contact with one another;
wherein, when the substrate and the test sample move relative to one another, a portion of the semisolid material is deposited upon the substrate.

4. The apparatus of claim 3 further comprising:
a test arm assembly attached to the base assembly, the holder being attached to the test arm assembly;
wherein the substrate moves relative to the base assembly, thereby resulting in a movement of the substrate relative to the holder in a first direction; and
wherein the test arm assembly is adapted for movement relative to the substrate in a second direction generally perpendicular to the first direction.
